(19) United States
(12) Patent Application Publication
(10) Pub. No.: US 2008/0210624 A1
(43) Pub. Date: Sep. 4, 2008

(54) The Preparation Method Of Exo-Pressure Type Poly(Vinylidene Fluoride) Hollow Fiber Membrane Spinned Utilizing A Immersion-Coagulation Method And The Product Thereof

(76) Inventors: Xiang Li, Huzhou Zhejiang Province (CN); Xiaomai Wang, Huzhou Zhejiang Province (CN)

Correspondence Address: BUTZEL LONG;IP DOCKETING DEPT, 350 SOUTH MAIN STREET, SUITE 300, ANN ARBOR, MI, 48104, US

(21) Appl. No.: 10/567,413

(22) PCT Filed: Aug. 5, 2004
(86) PCT No.: PCT/CN04/00899

§ 371 Date: Feb. 3, 2006

(30) Foreign Application Priority Data
Aug. 6, 2003 (CN) 03142158.X

(51) Int. Cl. B29C 47/00; B29C 47/04; B01D 69/08

(52) U.S. Cl. 210/500.23; 264/177.14; 264/45.5

(57) ABSTRACT

The invention relates to a preparation method of exo-pressure type poly(vinylidene fluoride) hollow fiber membrane spinned utilizing an immersion-coagulation method and the product thereof. The invention is performed mainly through the following steps: dissolving and stirring at a certain temperature to obtain a membrane forming solution; by means of a double-tube orifice, spinning the membrane forming solution together with a composite supporting solution which is in the inner tube of the orifice; after a rapid evaporation, performing the two-stage phase-separating coagulations; after a potch, hydrophilizating the resulted phase inversion membrane; thus, obtaining integrally and continuously the exo-pressure type hollow fiber membrane having double barrier layers and a completely spongy supporting layer. Therefore, the invention is provided with a lot of characteristics, such as the formulation of the membrane forming solution being reasonable, the evaporation and immersion spinning method, the two-stage phase-separation coagulations, and the hydrophilization treatment, as well as the technique for forming membrane integrally and continuously being simple and easy without high restricts to device, the technique process being controlled easily, etc. And the membrane is provided with high compression strength and large water permeation flux, and its property is deteriorated very slowly, and cut-off deposits are difficult to formed on the membrane surface.

### BACKGROUND OF THE INVENTION

1. Field of the Invention

The present invention relates to a method of producing hollow fiber membranes, in particular, the present invention relates to a method of producing an outside-in polyvinylidene fluoride hollow fiber membranes that are spun utilizing an immersion-coagulation process and a formulation for polymer solution which produces the membrane thereof, comprising high molecular weight polyvinylidene fluoride resin and high proportional organic additives, and relates to a hollow fiber membranes produced by the method and the polymer solution as well.

2. Background of the Invention

Polyvinylidene fluoride resins (PVDF) have been regarded as one of the most important materials for membrane separation technology, which have excellent separating properties and chemical stability.

Production of separation membranes from PVDF resins using a spun immersion-coagulation process (or namely immersion-precipitation process) are well known in the prior art. Polymeric membranes may be prepared by phase inversion technique which commences with the formation of a molecularly homogeneous, single phase solution of a polymer in a solvent. The solution is then allowed to undergo transition into a heterogeneous, metastable mixture of two interspersed liquid phases one of which subsequently forms a gel. Phase inversion can be achieved by solvent evaporation, non-solvent precipitation and thermal precipitation. In the case of immersion-coagulation process (or namely immersion-precipitation process), phase inversion is achieved by precipitation of non-solvent in accordance with polymer, so that polymeric membrane is prepared. In the field, the process can also be called NIPS (non-solvent induced phase separation), and the most known non-solvent of PVDF resin includes water and alcohols such as ethanol, with water being particularly preferred because it is the most inexpensive non-solvent and can be used in large amount. For example, U.S. Pat. No. 4,399,035 discloses that any non-solvent of polyvinylidene fluoride type resin may be used as the coagulating liquid, and that water is particularly preferred because it is the most inexpensive non-solvent and can be used in large amount.

In conventional processes, polyvinylidene fluoride resins (PVDF) used in accordance with the membrane formation generally have an average molecular weight (Mw) ranging from 30,000 to 200,000, which ensures that the prepared hollow fiber membrane will have more strength by increasing the weight percent of the PVDF resins in the solution. For example, U.S. Pat. No. 5,066,401 discloses membranes which were based on a homogeneous mixture of polyvinylidene fluoride resins. The solution contained 70 to 98 percent by weight of polyvinylidene fluoride. However, increased concentration of the PVDF resins consequentially resulted in high melting temperature (the melting temperature for the solution of the above mentioned membrane is up to be more than 240° C.). This has a disadvantage of untimely secondary effect of thermally induced phase separation, which will certainly influence the structure of the prepared membrane. On the other hand, such hollow fiber membrane prepared by the method has desirable strength in some measure, but the porosity is unfortunately low. Especially while the polymer melted with higher temperature, more gas and cavity is discharged which results in higher density of the solution and lower porosity and large pore size (the average pore size of the above mentioned prepared membrane is 0.45μm).

However, PVDF is one kind of hydrophobic resin, so it tends to form hydrophobic dense skins while formation. Furthermore, lower molecular weight PVDF resins usually means larger pore size, and higher molecular weight PVDF resins usually means smaller pore size of the prepared membrane. Many PVDF membranes are reported, such as flat porous membranes, hollow fiber inside-out membranes, etc., most of these membranes have nominal pore size in the range of 0.1 μm -0.45 μm, and the structure of cross-sectional supporting layer mostly includes bidirectional macroporous of finger-structure and needle-structure, directional macroporous of finger-structure, or partial macroporous of finger-structure, and the like, throughout the cross-section of the membranes.

Asymmetrical membranes usually comprise porous supporting layers and thin skins, and there will be observed macroporous finger-structures and needle-structures throughout the supporting layer result from liquid-liquid phase separation (shown in FIG. 6 and FIG. 7). However, the macroporous structure will obviously be disadvantageous for the prepared membrane, as there will be weak parts in the prepared membrane and which will be even easy to be deposition while filtration application.

Though porous PVDF hollow fiber membranes prepared by conventional process have skin layers, the macropores of their supporting layers will damage the mechanical strength (as an example of Japanese patent of JP 1-22003B).

In order to improve process technique, an application for a method of PVDF hollow fiber porous membrane was filed for a Chinese patent (App. No. 95117497.5) which discloses a method of forming PVDF hollow fiber membranes with macropores having high permeability and asymmetrical structure, via wet-dry process, of which the polymer solution included the following substances: polyvinylidene fluoride 15-25 wt %, nonsolvent 0.5-5 wt %, surfactant 1-10 wt %, high molecular pore-forming agent 1-20 wt % and solvent 40-82.5 wt %.

And a further Chinese patent application ( No.98103153.6) was filed for a method of PVDF hollow fiber porous membranes and the products thereof, which discloses a method for preparing PVDF hollow fibre porous membranes via a dry-wet method, in which the prepared membrane was stretched with the stretch ratio controlled at 60-300%. The porous membrane had 0.1-1 μm of nominal pore size, 300-1000 L/ m2.h (0.1 MPa) of purified water throughput and 70-90% of porosity.

All of these known hollow fiber membranes have the disadvantage that the compressive strength will easily be influenced during applications, and contamination will easily be deposited on the surface of the membranes, and the membrane performance will attenuation. Furthermore, due to surface tension of the water, the ultrafiltration membrane manufactured by conventional techniques which mostly have such micropore that the water flux is lower, and limits their application in the field of water treatment.

### SUMMARY OF THE INVENTION

The present invention solves the problem of conventional techniques which causes the proportion of lower molecular weight PVDF resins to be unsuitable for preparing polymer solution, the preparing process to be too complicated, and is also to solve the problem of conventional techniques in which water permeability of the prepared membrane is not high enough, and the problems of undesirable mechanical properties, undesirable permeability stability and short service life, due to macroporous finger-structure supporting layer of the prepared membranes for higher water flux.

It is an object of the present invention to provide a polymer solution formulation which produces the membranes thereof, comprising high molecular weight polyvinylidene fluoride resin and high proportional organic additives (as pore-forming agent), and a method of producing an outside-in PVDF hollow fiber membrane spun utilizing immersion-coagulation process.

It is another object of the present invention to provide a microporous outside-in PVDF hollow fiber ultrafiltration membrane, which has asymmetrical structure with opposite inner and outer skins, and has porous supporting layer of sponge-structure network, and the said porous supporting layer is not macroporous throughout the cross-section.

According to the present invention, a method to prepare a microporous outside-in PVDF hollow fiber membranes which are spun by immersion and coagulation, comprises:

a. preparing polymer solution by introducing the following material into a mixer, dissolving and stirring it the mixture at a certain temperature:

| | | |
|---|---|---|
| Polyvinylidene Fluoride | 18-25% | (wt); |
| Organic additives | 22-25% | (wt); |
| Inorganic additives | 0.5-5.0% | (wt); |
| Solvent | 59.5-45.0% | (wt). |

b. extruding the resulting solution through an outer tube of a double tube spinneret, and lumen forming composition liquid through inner tube of the same simultaneously;
c. obtaining original fiber membrane by introducing and immersing the extruded polymer solution as well as the lumen liquid into a first stage coagulation bath, and consequently into a second coagulation bath after quick evaporization, wherein a precipitation takes place via phase inversion in the said two baths respectively;
d. passing the original fiber membrane through a rinsing bath, subjecting it to hydrophilic rendering;
then an outside-in hollow fiber with double skins and complete spongy network is prepared.

As polyvinylidene fluoride resins from which the microporous hollow fiber membrane of the present invention is prepared, there are high molecular weight vinylidene fluoride homopolymers, which are useful to ensure the desired mechanical properties of the prepared membrane, and to avoid the problem such as bad melting flowability and moldability due to high concentration of PVDF resin. On the other hand, the use of such polyvinylidene fluoride resins combined with higher proportional organic additives (which acts as pore-forming agent) has solved the problem which will affect the properties of the prepared membrane, and created a good condition for preparing the said membrane according to the present invention.

According to the present invention the weight molecular weight (Mw) of the polyvinylidene fluoride resins ranges from 400,000 to 800,000 daltons, and a characteristic viscosity of the polyvinylidene fluoride resins ranges from 1.65-2.00 (102 ml/g. 30° C.).

Preferably, the molecular weight (Mw) ranges from 500,000 to 700,000 daltons, and a characteristic viscosity ranges from 1.75-1.85 (102 ml/g. 30° C.). If there is more than one kind of PVDF resins, the total amount shall be constant.

According to the present invention, while the polymer solution is prepared, and is extruded through a double tube spinneret, after quick evaporation (preferably 0.02-0.2 seconds), subsequently the resulting extrudate is immersed in at least a coagulating bath where a exchange between the coagulating liquid and the solvent happens simultaneously on the both surfaces of outside and inside of the original fiber. The exchange on the both surfaces interact each other and will consequently influence the final structure of the prepared fiber.

As in well-known in the case of using non-solvent as coagulation liquid, during the first coagulation period, there generally have too high exchange rate between the coagulating liquid and solvent, this would either cause the formation of a large pore size and macroporous supporting layer structure of the prepared membrane, or cause incomplete exchange and thus lower porosity, because, while the solvent is continuously exchanged from the solution, the component of the coagulation continuously is changed, and the exchange rate becames less and less, and consequently decreases the coagulating effect.

For these reasons, it is helpful to control exchange rate between the solvent and the coagulation liquid, in order to decrease the precipitation velocity on the two skins of the original membrane, which are the inner and outer skins, via a two stage coagulation process. Furthermore, for the same purpose, it is helpful to add a certain content of solvent for the PVDF resin to coagulation liquid which comprises a non-solvent for said PVDF resin, so as to decrease the concentrate difference of the solvent between the coagulation liquid and the original membrane and control diffusion and exchange dynamic forces.

According to the present invention, the method immersing the resulting extrudate into a two stage coagulating bath, so as to control the solvent exchange rate of the outside skin of the original fiber, for a time of 1.5 s to 4.0 s in the first bath containing 40-80% by weight of solvent, and then into the second bath containing 5-30% by weight of solvent for 4 s to 120 s, for the purpose of delaying phase separation. It is very important to ensure that the exchange rate of the inside skin (the lumen forming liquid) is faster than that of the outside one.

According to the present invention, the lumen forming composition liquid consists of 10-80% by weight of solvent of PVDF resins, 5-30% by weight of alcohol and polyalcohol, 0.5-5% by weight of surfactant, and deionized water.

According to the present invention, the method also includes controlling the solvent exchange rate of the inside skin, decreasing the precipitation velocity so as to avoid macropore and neckdown phenomenons that can result from the viscosity of the lumen liquid while under traction.

According to the present invention, a microporous outside-in PVDF hollow fiber ultrafiltration membrane is prepared with partial cross-section of gradually increscent sponge network that is porous from outside skin to inside (as shown in FIGS. 1-5). This solves the problem that there are macropore in the structure of the hollow fiber prepared by conventional technology.

According to the present invention, the kinds and concentration of additives are also key factors for the property of the prepared fiber. For various polymer solution systems, there are large differences of influence with same additives. For example, the more molecular weight of an additive such as polyvinylpyrrolidone (PVP) etc. always influences macropore, which can change molecular crosslinking degree of the solution, while less molecular weight additive such as lithium chloride etc. influences micropore. The additive with less molecular weight can enter the voids between the molecule chain of the polymer and is introduced to the functional groups, which improve the stability of the prepared fiber. Generally, suitable ratios of various additives will be helpful to obtain desirable pore diameter pattern and improved flux of the prepared fiber.

According to the present invention, besides the above mentioned factors which affect the properties of the prepared fiber, the pore-forming agent also influences the pore diameter pattern. Partially the agent acts as filler of the voids among the polymer solution. During the coagulation. process of the extruded fiber, the pore-forming agent will be extracted, and while the agent and solvent diffuse and exchange, thereby voids are formed throughout the fiber. To obtain fiber with desirable porosity and pore diameter, it is important to control the concentration of the pore-forming agent and diffusion velocity of the same.

According to the present invention, a high desirable concentration of organic additives is used to decrease the melting temperature of the PVDF polymer. This is conduced to prepare homogenous polymer solution. Furthermore the organic additives also act as pore-forming agents. Preferably, the said organic additive consists of at least two of the groups of polyvinylpyrrolidone, polyethylene glycol, polyvinyl alcohol, Tween and Triton. If the additives are more than two kinds, the total amount is constant.

According to the present invention, the polymer solution comprises 22-25% by weight of the said organic additive. Preferably, the organic additive is polyvinylpyrrolidone having a molecular weight ranging from 11,000 to 1,000,000 daltons.

According to the present invention, the inorganic additive is selected one or two from the group comprising lithium chloride, lithium nitrate and sodium acetate solution. If the additives are more than two kinds, the total amount is constant.

According to the present invention, the solvent is selected one or two from the group comprising N-Methyl Pyrrolidone, dimethylformamide, dimethy lacetamide, dimethyl sulfoxide and triethyl phosphate. If the solvent is more than two kinds, the total amount is constant. The results of the solvent show formation of the original skins which are helpful to improve exchange rate of the solvent.

According to the present invention, the lumen forming liquid is a mixture comprising 10-80% by weight of solvent of PVDF, 5-30% by weight of alcohol and polyalcohol, 0.5-5% by weight of surfactant and a balance of deionized water.

According to the present invention, the evaporating time before phase separation is preferably ranges from 0.02 s to 0.2 s; the first stage coagulating bath preferably comprises 40-80% by weight of solvent of PVDF resin in which the time of coagulation is 1.5 s to 4.0 s; and the second stage bath preferably comprises 40-80% by weight of solvent of PVDF resin in which the time of coagulation is 4.0 s to 120 s.

According to the present invention, the hydrophilic agent is selected at least one or more from the group comprising 10-80% by weight of propanetriol, 0.05-5% by weight of hydroxypropyl cellulose and 0.5-5% by weight of Triton.

According to the above mentioned process, a microporous outside-in PVDF hollow fiber ultrafiltration membrane is prepared that has double skins which are internal and external in which said external skin is denser than said internal skin, and a complete sponge network supporting layer of the cross-section between the internal and external.

The microporous hollow fiber membrane according to the present invention has an norminal pore diameter ranging from 0.01 μm to 0.06 μm.

Furthermore, the microporous hollow fiber membrane according to the present invention has a porosity of 70%-85%, a compressive strength of more than 0.5 Mpa, and a pure water flux per unit wall thickness of 150 to 800 L/m2h (25° C., 1 bar).

As described above, compared to conventional techniques, the method of preparing a microporous hollow fiber membrane of the present invention, including integrated and continuous process of evaporation, immersed spinning, two stage phase separation and coagulation, hydrophilic rendering, is simple and feasible. The resulting membrane has properties of high compressive strength, high flux, high contamination removal ability, and high performance stability. The membranes of the present invention are useful in a variety of application such as biochemical, food, medical, brewing and purifying industry, and domestic applications as well.

### BRIEF DESCRIPTION OF THE DRAWINGS

FIG. 1 is an electron micrograph of a cross-section of a hollow fiber membrane according to the present invention;

FIG. 2 is an electron micrograph of a part cross-section of a hollow fiber membrane according to the present invention;

FIG. 3 is an electron micrograph of the external skin of a hollow fiber membrane according to the present invention;

FIG. 4 is an electron micrograph of the sponge-structure supporting layer of a hollow fiber membrane according to the present invention;

FIG. 5 is an electron micrograph of a longitudinal section of a hollow fiber membrane according to the present invention;

FIG. 6 is an electron micrograph of a cross section of a conventional hollow fiber membrane;

FIG. 7 is another electron micrograph of a cross section of a conventional hollow fiber membrane.

### DESCRIPTION OF THE PREFERRED EMBODIMENT

The invention is further described by examples and combining with figures as following.

### EXAMPLE 1

As shown in Table 1, 18% by weight of polyvinylidene fluoride resin (FR904 as trade name available from Shanghai 3F company) having a molecular weight of 800,000 daltons and a characteristic viscosity of 1.95 (102 ml/g. 30° C.); 12.5% by weight of polyvinylpyrrolidone having a molecular weight of 45,000 daltons (PVP K-30, K-90 as trade name available from Shanghai Shenpu Co.); 8% by weight of PEG-600 (imported from Japan); 1.5% by weight of Tween-80 (imported from Japan); 0.5% by weight of lithium nitrate; 29.5% by weight of N-Methyl Pyrrolidone (available from Shanghai chemical reagent Co.); and 30% by weight of dimethylacetamide (available from BASF Co.) were added in order and blended together in a mixer. The resultant mixture was melted stirring at 85° C., and continuously degassed so as to be a homogenous dope. The resultant solution was then extruded through a outer tube of a double tube spinneret while holding the temperature of 80° C. and co-extruded with the lumen forming liquid through inner tube of the same simultaneously. The lumen forming liquid consists of 50% by weight of solvent of PVDF, 8% by weight of alcohol and polyalcohol, 5% by weight of surfactant and 37% by weight of deionized water (shown in Table 3). The resulting extrudate was evaporated while passing it through the air for a short time of 0.1 s, and then passed through the first stage aqueous coagulating bath for 4 s, which containing 40% by weight of solvent of PVDF resin, and then passed through the second stage aqueous coagulating bath containing 5% by weight of solvent of PVDF resin for 60 s by traction. The hollow fiber-shaped extrudate thus obtained was subsequently subjected to water washing, hydrophilic rendering with which the composition of 50% by weight of propanetriol, 0.1% by weight of hydroxypropyl cellulose and 1.0% by weight of Triton (shown in Table 2) and drying. Finally, the prepared hollow fiber membrane was taken up on the gathering wheel.

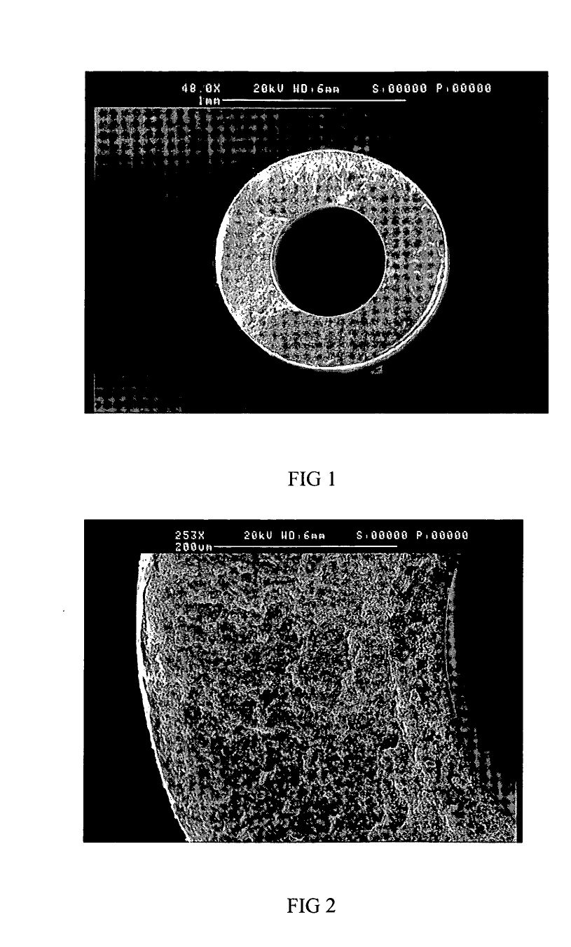

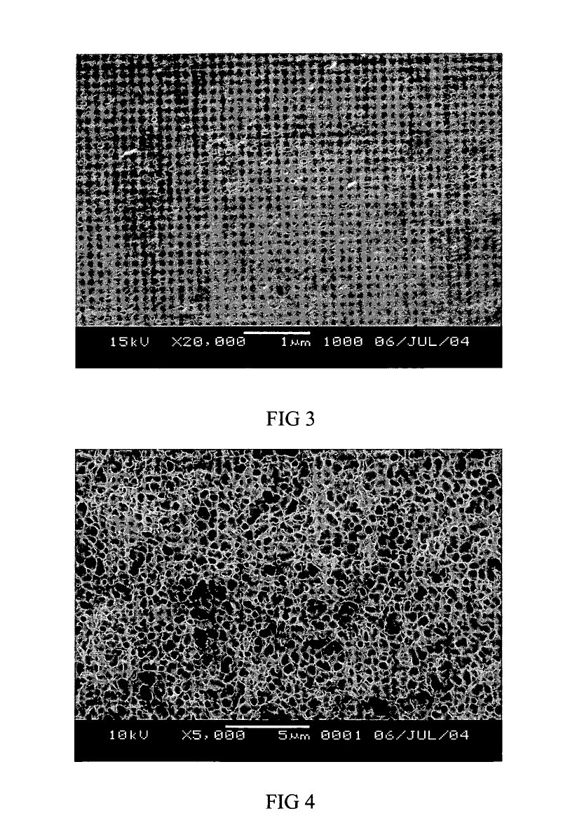

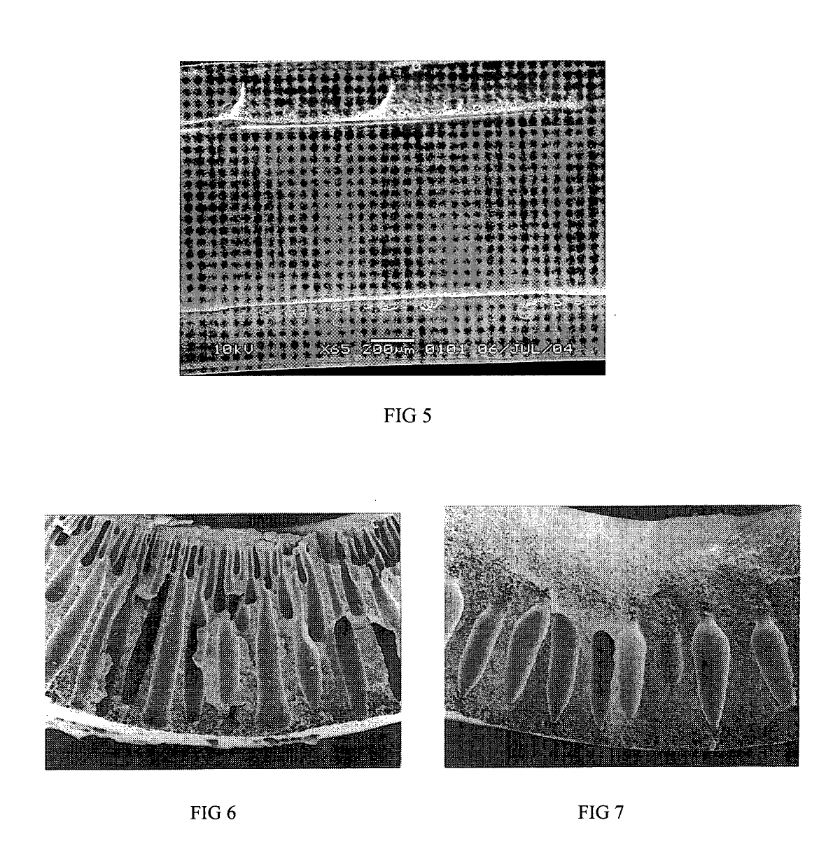

The prepared hollow fiber membrane, out-to-in, has external skin 1, complete sponge-structure supporting layer 2 and internal skin 3 respectively, in the cross-section as shown in FIGS. 1-5.

The microporous hollow fiber membrane had an outer and inner diameter of 1.25 mm, 0.65 mm respectively, an average pore diameter of 0.045 μm, and a porosity of 75%. The compressive strength of the microporous hollow fiber membrane was 0.5 Mpa, and the purity water flux per unit wall thickness was 450 L/m2h (at 25° C., 1 bar).

### EXAMPLE 2˜10

Example 1 was repeated to prepare a microporous hollow fiber membrane except for various blend components and technique parameters used which are listed in Tables 1, 2 and 3, respectively. The properties of the prepared membranes are shown in Table 4.

### EXAMPLE 11

18% by weight of polyvinylidene fluoride resin (FR904 as trade name available from Shanghai 3F company) having a molecular weight of 800,000 daltons; 12.0% by weight of polyvinylpyrrolidone having a molecular weight of 45,000 daltons (PVP K-30 as trade name available from Shanghai Shenpu Co.); 0.5% by weight of polyvinylpyrrolidone having a molecular weight of 1,000,000 daltons (available from Nanjing Jinlong Co.); 8% by weight of PEG-600 (imported from Japan); 1.5% by weight of Tween-80 (imported from Japan); 0.5% by weight of lithium nitrate; 29.5% by weight of N-Methyl Pyrrolidone (available from Shanghai chemical reagent Co.); and 30% by weight of dimethylacetamide (available from BASF Co.) were added in order and blended together in a mixer. The resultant mixture was melted while stirring at 85° C., and continuously degassed so as to produce a homogenous dope. The resultant dope was then extruded through outer tube of a double tube spinneret while holding the temperature of 80° C. and co-extruded with the lumen forming liquid through inner tube of the same simultaneously. The resulting extrudate was evaporated while passing it through the air for a short time of 0.05 s, then passed through the first stage aqueous coagulating bath for 3 s, which contained 45% by weight of solvent of PVDF resin, and then through the second aqueous coagulating bath containing 10% by weight of solvent of PVDF resin for 80 s. The hollow fiber-shaped extrudate thus obtained was subsequently subjected to water washing, hydrophilic agent rendering (shown in Table 2) and drying. Finally, the prepared hollow fiber membrane was taken up on the gathering wheel.

The prepared hollow fiber membrane, out-to-in, has external skin 1, complete sponge-structure supporting layer 2 and internal skin 3 respectively, in the cross-section as shown in FIGS. 1, 2, 3, 4 and 5.

The microporous hollow fiber membrane had an outer and inner diameter of 1.25 mm, 0.65 mm respectively, an average pore diameter of 0.045 μm, and a porosity of 78%. The compressive strength of the microporous hollow fiber membrane was 0.5 Mpa, and the purity water flux per unit wall thickness was 450 L/m2h (at 25° C., 1 bar).

The properties of the prepared hollow fiber membrane are shown in Table 4.

### EXAMPLE 12

Example 1 was repeated to prepare a microporous hollow fiber membrane except for 20.5% by weight of polyvinylidene fluoride resin (1700 as trade name available from Kureha in Japan,) having a molecular weight of 500,000 daltons; 9.5% by weight of polyvinylpyrrolidone having a molecular weight of 45,000 daltons (PVP K-30 as trade name available from Shanghai Shenpu Co.); 12% by weight of PEG-400 (imported from Japan); 1.0% by weight of Tween (imported from Japan); 0.5% by weight of lithium chloride; 56.5% by weight of dimethylacetamide (available from BASF Co.).

The resulting extrudate was evaporated while passing it through the air for a short time of 0.02 s, then passed through the first stage aqueous coagulating bath for 1.5 s, which contained 60% by weight of solvent of PVDF resin, and then through the second aqueous coagulating bath containing 30% by weight of solvent of PVDF resin for 30 s.

The prepared hollow fiber membrane has double skins which are internal and external, and a complete sponge-structure supporting layer in the cross-section.

The microporous hollow fiber membrane had an outer and inner diameter of 1.25 mm, 0.65 mm respectively, an average pore diameter of 0.06 μm, and a porosity of 80%. The compressive strength of the microporous hollow fiber membrane was more than 0.5 Mpa, and the water flux per unit wall thickness was 750 L/m2h (at 25° C., 1 bar).

### EXAMPLE 13

Example 1 was repeated to prepare a microporous hollow fiber membrane except for 20.5% by weight of polyvinylidene fluoride resin (SOLEF6020 as trade name available from Solvay,) having a molecular weight of 400,000 daltons; 10.5% by weight of polyvinylpyrrolidone having a molecular weight of 45,000 daltons (PVP K-30 as trade name available from Shanghai Shenpu Co.); 10% by weight of PEG-300 (imported from Japan); 1.5% by weight of polyvinylalcohol; 5% by weight of 20% sodium acetate aqueous solution; 52.5% by weight of dimethylacetamide (available from BASF Co.).

The resulting extrudate was evaporated while passing it through the air for a short time of 0.2 s, then passed through the first stage aqueous coagulating bath for 2.0 s, which contained 80% by weight of solvent of PVDF resin, and then through the second aqueous coagulating bath containing 20% by weight of solvent of PVDF resin for 4 s.

The prepared hollow fiber membrane has double skins which are internal and external, and a complete sponge-structure supporting layer in the cross-section.

The microporous hollow fiber membrane had an outer and inner diameter of 1.25 mm, 0.65 mm respectively, an average pore diameter of 0.055 μm, and a porosity of 80%. The compressive strength of the microporous hollow fiber membrane was more than 0.5 Mpa, and the water flux per unit wall thickness was 460 L/m2h (at 25° C., 1 bar).

### EXAMPLE 14

Example 1 was repeated to prepare a microporous hollow fiber membrane except for 19.0% by weight of polyvinylidene fluoride resin (SOLEF6030 as trade name available from Solvay,) having a molecular weight of 500,000 daltons; 9.0% by weight of polyvinylpyrrolidone having a molecular weight of 45,000 daltons (PVP K-17 as trade name available from Shanghai Shenpu Co.); 11% by weight of PEG-300 (imported from Japan); 4% by weight of polyvinyl alcohol; 2.0% by weight of Tween-80 (imported from Japan); 5% by weight of triethyl phosphate (C.P.); 50.0% by weight of dimethylacetamide (available from BASF Co.).

The resulting extrudate was evaporated while passing it through the air for a short time of 0.15 s, then passed through the first stage aqueous coagulating bath for 2.5 s, which containing 50% by weight of solvent of PVDF resin, and then through the second aqueous coagulating bath containing 25% by weight of solvent of PVDF resin for 120 s.

The prepared hollow fiber membrane has double skins which are internal and external, and a complete sponge-structure supporting layer in the cross-section.

The microporous hollow fiber membrane of the present invention had an outer and inner diameter of 1.20 mm, 0.60 mm respectively, an average pore diameter of 0.015 μm, and a porosity of 75%. The compressive strength of the microporous hollow fiber membrane was 0.5 Mpa, and the water flux per unit wall thickness was 450 L/m2h (at 25° C., 1 bar).

TABLE 1
Formulation of the present invention

| | | Example | | | | | | | | | |
|---|---|---|---|---|---|---|---|---|---|---|---|
| Component | | 1 | 2 | 3 | 4 | 5 | 6 | 7 | 8 | 9 | 10 |
| PVDF | Concentration | 18 | 20.5 | 20.5 | 19 | 20 | 25 | 20 | 22 | 19 | 23 |
| | (wt %) | | | | | | | | | | |
| | Characteristic | 1.95 | 1.75 | 1.7 | 1.75 | 1.8 | 1.65 | 1.85 | 1.68 | 1.87 | 1.65 |
| | Viscosity | | | | | | | | | | |
| | Molecular Weight | 800000 | 500000 | 450000 | 500000 | 600000 | 400000 | 650000 | 400000 | 680000 | 400000 |
| | (dalon) | | | | | | | | | | |
| Organic | PVP (wt %) | k-30:12 | k-30:9.5 | K-30:10.5 | K-17:9.0 | K-17:12 | K-17:10.0 | K-30:8 | K-17:12 | K-30:10 | K-30:8 |
| Additive | | k-90:0.5 | | | | | | | | | |
| | PEG (wt %) | PEG-600 | PEG-400 | PEG-300 | PEG-300 | PEG-600 | PEG-600 | PEG-800 | PEG-400 | PEG-600 | PEG-400 |
| | | 8 | 12 | 10 | 11 | 12 | 12 | 10 | 10 | 10 | 5 |
| | Polyvinyl Alcohol | | | 1.5 | 4.0 | | 2 | 2 | | | 8 |
| | (wt %) | | | | | | | | | | |
| | Tween (wt %) | 1.5 | | | 2.0 | | | 2 | | 2.0 | |
| | Triton (wt %) | | 1.0 | | | 1.0 | | | 0.5 | | 1.0 |
| Inorganic | Lithium Chloride | | 0.5 | | | | | 4.0 | 3.5 | | |
| Additive | (wt %) | | | | | | | | | | |
| | Lithium nitrate | 0.5 | | | | | | | | 3.0 | |
| | (wt %) | | | | | | | | | | |
| | Sodium Acetate | | | 5.0 | | | | | | | |
| | wt % | | | | | | | | | | |
| | Sodium Nitrate | | | | | | 1.0 | | | | 0.5 |
| | (wt %) | | | | | | | | | | |
| Solvent | NMP (wt %) | 29.5 | | | | | | 10 | | 50 | 50 |
| | DMF (wt %) | | | | 50 | | | | 50 | | |
| | DMA (wt %) | 30 | 56.5 | 52.5 | | | 40 | 44 | | | |
| | Dimethyl | | | | | 55 | | | | 6 | |
| | Sulfoxide (wt %) | | | | | | | | | | |
| | Triethyl | | | | 5 | | | | 2 | | 4.5 |
| | Phosphate (wt %) | | | | | | | | | | |

TABLE 2
Hydrophilic Agent for the Present Invention

| | | Example | | | | | | | | | |
|---|---|---|---|---|---|---|---|---|---|---|---|
| Component | | 1 | 2 | 3 | 4 | 5 | 6 | 7 | 8 | 9 | 10 |
| Agent | Propanetriol (wt %) | 50 | 60 | 45 | 35 | 35 | 50 | 50 | 50 | 10 | 80 |
| | Hydroxypropyl | 0.1 | 0.1 | 0.1 | 0.1 | 0.2 | 0.1 | 0.3 | 0.1 | 5.0 | 0.05 |
| | Cellulose | | | | | | | | | | |
| | (wt %) | | | | | | | | | | |
| | Triton (wt %) | 1.0 | 0.5 | 1.0 | 5.0 | 1.0 | 2.0 | 1.0 | 1.0 | 5.0 | 1.0 |

TABLE 3
Lumen Forming Liquid for the Present Invention

| | Example | | | | | | | | | |
|---|---|---|---|---|---|---|---|---|---|---|
| Component | 1 | 2 | 3 | 4 | 5 | 6 | 7 | 8 | 9 | 10 |
| PVDF Solvent | 50 | 45 | 40 | 45 | 42 | 60 | 80 | 45 | 50 | 10 |
| (wt %) | | | | | | | | | | |
| Alcohol and | 8 | 10 | 12 | 10 | 10 | 9 | 5 | 10 | 11 | 30 |
| Polyalcohol | | | | | | | | | | |
| (wt %) | | | | | | | | | | |
| Surfactant | 5 | 0.5 | 1 | 2.0 | 2 | 0.5 | 0.5 | 2 | 3 | 5 |
| (wt %) | | | | | | | | | | |
| Deionized | 37 | 44.5 | 47 | 43 | 46 | 30.5 | 14.5 | 43 | 36 | 55 |
| Water | | | | | | | | | | |
| (wt %) | | | | | | | | | | |

TABLE 4
Properties of the Prepared membrane for the Present Invention

| | Example | | | | | | | | | |
|---|---|---|---|---|---|---|---|---|---|---|
| Parameter | 1 | 2 | 3 | 4 | 5 | 6 | 7 | 8 | 9 | 10 |
| Nominal Pore Size (μm) | 0.045 | 0.06 | 0.055 | 0.05 | 0.025 | 0.01 | 0.032 | 0.022 | 0.06 | 0.045 |
| Porosity (%) | 75 | 80 | 80 | 75 | 80 | 70 | 80 | 80 | 80 | 85 |
| Water Flux per Unit Wall | 450 | 750 | 500 | 450 | 300 | 150 | 220 | 350 | 800 | 600 |
| Thickness | | | | | | | | | | |
| L/m² h (at 25° C., 1 bar) | | | | | | | | | | |
| Compressive Strength (Mpa) | 0.50 | 0.55 | 0.52 | 0.54 | 0.52 | 0.51 | 0.51 | 0.53 | 0.50 | 0.50 |

1. A method for preparing a microporous outside-in PVDF hollow fiber membrane which is spinned by immersion and coagulation, which method comprises the steps of:
a. preparing polymer solution by introducing the following material into a mixer, dissolving and stirring the resulting solution:

| | | |
|---|---|---|
| Polyvinylidene Fluoride | 18-25% | (wt); |
| Organic additives | 22-25% | (wt); |
| Inorganic additives | 0.5-5.0% | (wt); |
| Solvent | 59.5-45.0% | (wt). |

b. extruding the solution obtained in step a through an outer tube of a double tube spinneret, and a lumen forming composition liquid through an inner tube of the double tube spinneret simultaneously;
c. obtaining a fiber membrane by introducing and immersing the extruded polymer solution as well as the lumen forming composition liquid into a first stage coagulation bath, and consequently into a second coagulation bath after quick evaporization, wherein a precipitation takes place via phase inversion in the two baths respectively;
d. passing the fiber membrane from step c through a rinsing bath so as to subject the fiber membrane to hydrophilic rendering and produce an outside-in hollow fiber with double skins and complete spongy network.

2. The method of claim 1, wherein the organic additives comprises of at least one of polyvinylpyrrolidone, polyethylene glycol, polyvinyl alcohol, Tween and Triton. Triton.

3. The method of claim 1, wherein the inorganic additives comprises at least one of lithium chloride, lithium nitrate and sodium acetate solution.

4. The method of claim 1, wherein the solvent comprises at least one of N-Methyl Pyrrolidone, dimethylformamide, dimethylacetamide, dimethyl sulfoxide and triethyl phosphate.

5. The method of claim 1, wherein the lumen forming liquid comprises 10-80% by weight of a solvent for PVDF, 5-30% by weight of alcohol and polyalcohol, 0.5-5% by weight of a surfactant and a balance of deionized water.

6. The method of claim 1, wherein the molecular weight of the polyvinylidene fluoride resins range from 400,000 to 800,000 daltons, and the a characteristic viscosity of the polyvinylidene fluoride resins from 1.65-2.00.

7. The method of claim 1, wherein the characteristic viscosity for the PVDF resin is 1.75-1.85, and the molecular weight of the PVDF resin is 500,000 to 700,000 daltons.

8. The method of claim 1, wherein the organic additive is polyvinylpyrrolidone, having a molecular weight ranging from 11,000 to 1,000,000 daltons.

9. The method of claim 1, wherein the evaporation time ranges from 0.02 s to 0.2 s; the first stage coagulation bath comprises 40-80% by weight of a solvent for PVDF resin and the immersion time in the first stage coagulation bath is 1.5 s to 4.0 s; and the second stage coagulating bath comprises 40-80% by weight of a solvent of PVDF resin and the immersion time in the second stage coagulation bath is 4.0 s to 120 s.

10. The method of claim 1, wherein a hydrophilic agent is used in step d which comprises 10-80% by weight of propanetriol, 0.05-5% by weight of hydroxypropyl cellulose and 0.5-5% by weight of Triton.

11. The method of claim 14, wherein a hydrophilic agent is used in step d which comprises 10-80% by weight of propanetriol, 0.05-5% by weight of hydroxypropyl cellulose and 0.5-5% by weight of Triton.

12. The membrane of claim 1, wherein the hollow fiber has double skins which are internal and external and a complete sponge network supporting layer in the cross-section; wherein the external skin is denser than the internal skin; the microporous hollow fiber membrane has an average pore diameter ranging from 0.01 μm to 0.06 m, a water flux per unit wall thickness of 150 to 800 L/m² h (at 25° C., 1 bar), a porosity of 70-85%, and a compressive strength of more than 0.5 Mpa.

13. The membrane of claim 14, wherein the hollow fiber has double skins which are internal and external and a complete sponge network supporting layer in the cross-section; wherein the external skin is denser than the internal skin, the microporous hollow fiber membrane has an average pore diameter ranging from 0.01 μm to 0.06 μm, a water flux per unit wall thickness of 150 to 800 L/m²h (at 25° C. 1 bar), a porosity of 70-85%, and a compressive strength of more than 0.5 Mpa.

14. A method for preparing a microporous outside-in PVDF hollow fiber membrane which is spinned by immersion and coagulation, which method comprises the steps of:
a. preparing polymer solution by introducing the following material into a mixer, dissolving and stirring the resulting solution:

| | | |
|---|---|---|
| Polyvinylidene Fluoride | 18-25% | (wt); |
| Organic additives | 22-25% | (wt); |
| Inorganic additives | 0.5-5.0% | (wt); |
| Solvent | 59.5-45.0% | (wt) |

wherein the molecular weight of the polyvinylidene fluoride ranges from 400,000 to 800,000 daltons and the polyvinylidene fluoride has a characteristic viscosity that ranges from 1.6 to 2.0 (10²ml/g, 30° C.);
b. extruding the solution obtained in step a through an outer tube of a double tube spinneret, and a lumen forming composition liquid through an inner tube of the double tube spinneret simultaneously;
c. obtaining a fiber membrane by introducing and immersing the extruded polymer solution as well as the lumen forming composition liquid into a first stage coagulation bath, and consequently into a second coagulation bath after quick evaporization, wherein a precipitation takes place via phase inversion in the two baths respectively;
d. passing the fiber membrane from step c through a rinsing bath so as to subject the fiber membrane to hydrophilic rendering and produce an outside-in hollow fiber with double skins and complete spongy network.

15. The method of claim 14, wherein the characteristic viscosity for the PVDF resin is 1.75-1.85, and the molecular weight of the PVDF resin is 500,000 to 700,000 daltons.

16. The method of claim 14, wherein the organic additives comprises of at least one of polyvinylpyrrolidone, polyethylene glycol, polyvinyl alcohol, Tween and Triton.

17. The method of claim 14, wherein the organic additive is polyvinylpyrrolidone, having a molecular weight ranging from 11,000 to 1,000,000 daltons.

18. The method of claim 14, wherein the inorganic additives-comprises at least one of lithium chloride, lithium nitrate and sodium acetate solution.

19. The method of claim 14, wherein the solvent comprises at least one of N-Methyl Pyrrolidone, dimethylformamide, dimethylacetamide, dimethyl sulfoxide and triethyl phosphate.

20. The method of claim 14, wherein the lumen forming liquid comprises 10-80% by weight of a solvent for PVDF, 5-30% by weight of alcohol and polyalcohol, 0.5-5% by weight of a surfactant and a balance of deionized water.

21. The method of claim 14, wherein the evaporation time ranges from 0.02 s to 0.2 s; the first stage coagulation bath comprises 40-80% by weight of a solvent for PVDF resin and the immersion time in the first stage coagulation bath is 1.5 s to 4.0 s; and the second stage coagulating bath comprises 40-80% by weight of a solvent of PVDF resin and the immersion time in the second stage coagulation bath is 4.0 s to 120 s.
